(19) United States
(12) Patent Application Publication
(10) Pub. No.: US 2024/0392111 A1
(43) Pub. Date: Nov. 28, 2024

(54) LIPID-BASED BIOMASS DERIVED TIRE RUBBER COMPOSITION AND METHOD FOR MANUFACTURING THE SAME

(71) Applicant: HANKOOK TIRE & TECHNOLOGY CO., LTD., Seongnam-si (KR)

(72) Inventor: Bora KIM, Seongnam-si (KR)

(21) Appl. No.: 18/695,462

(22) PCT Filed: Sep. 28, 2022
(86) PCT No.: PCT/KR2022/014585

§ 371 Date: Mar. 26, 2024

(30) Foreign Application Priority Data
Sep. 30, 2021 (KR) 10-2021-0129821

(51) Int. Cl. C08K 11/00; C08K 3/04; C08K 5/05

(52) U.S. Cl. CPC C08K 11/005; C08K 3/04; C08K 5/05

(57) ABSTRACT

The present invention relates to a method for extracting and manufacturing from a lipid-based biomass such as carbon black, which is a petrochemical-based composition used in a tire rubber composition, a processing oil, an anti-aging agent, and free fatty acid spent coffee grounds, a tire rubber composition to which the same is applied, and a technology for an environmentally friendly and sustainable tire manufactured using the same. The all-in-one activator containing the processing oil, anti-aging agent, and free fatty acid is an integrated process that does not require a separate purification process for each chemical, and has an effect of improving economic efficiency by reducing production cost and an effect of preventing environmental pollution.

### TECHNICAL FIELD

This application claims priority to and the benefit of Korean Patent Application No. 10-2021-0129821 filed in the Korean Intellectual Property Office on Sep. 30, 2021, the entire contents of which are incorporated herein by reference.

The present invention relates to a lipid-based biomass-derived tire rubber composition and a method for manufacturing the same.

### BACKGROUND ART

As interests in sustainable technology are growing worldwide, research on replacing petroleum-based energy is being actively conducted, and the related technology trends are also rapidly changing. A tire industry has been considered to be separate from this worldwide demand for developing the sustainable technology, but eco-friendly tires are needed according to commercialization of electric vehicles and hydrogen cars of automobile manufacturers, the main customers. In particular, since tire tread is highly dependent on a petrochemical-based industry, efforts to replace petrochemical-based tire compositions with sustainable materials are being made. A representative trend is to replace various petrochemical-based compositions with waste biomass-based materials, wherein waste biomass has a complex structure and a vast variety of types and thus requires a complex or harsh process. This is directly related to a production cost, which makes it difficult to commercialize technology of using the waste biomass.

Since a compound for the tire tread uses dozens of different materials such as rubber and reinforcing materials, efforts to replace a conventional petrochemical-based tire composition have been made in various ways. For example, U.S. Patent Laid-Open Publication No. US20200190294A1 discloses a technique for replacing hydrocarbon-based resins with waxes containing nonacosanediols, U.S. Pat. No. 6,448,318B1 discloses a technique of using not petroleum-based but biomass-based processing oil such as soybean oil, sunflower seed oil, etc., and No. KR10-0369713B1 uses rice husk-based silica and the like as a reinforcing agent.

Efforts to use spent coffee grounds (SCGs) to prepare a tire rubber composition have been made, but they have only been spotlighted for replacing a portion of a reinforcing filler. Regarding a case of applying untreated spent coffee grounds to the compound after drying and pulverizing and a case of applying the spent coffee grounds to a rubber by adjusting functionality of the surface thereof with a liquid epoxidized natural rubber or bis-(3-triethoxysilylpropyl tetrasulfide) (TEPST) to vary a content thereof in the rubber, attempts to check changes in physical properties thereof have been made (MATEC Web of Conferences 157, 07009 2018; J. APPL. POLYM. SCI. 2017, DOI: 10.1002/APP.46060).

The present invention is to utilize lipid-based biomass such as the spent coffee grounds, of which a treatment problem is brought about with an increase in coffee consumption as a worldwide favorite food, in a tire rubber composition, and specifically, to utilize triglycerides including various chain lengths, free fatty acids, and phenols in the spent coffee grounds as processing oils, additives, and anti-aging agents of the tire rubber composition, and also, to use the remaining carbon-rich solid as a substitute for carbon black after conditional pyrolysis. The present invention is completed by securing original technology of preparing sustainable raw materials still keeping similar properties, when a conventional petrochemical-based composition used for tires is partially or entirely replaced with a lipid-based biomass-derived composition, and then confirming that this technology makes it possible to produce a cost-competitive and sustainable tire.

### DISCLOSURE

### Technical Problem

The present invention relates to the manufacture of a biomass-based tire rubber composition, a compound for a tire to which the same is applied, and a tire manufactured using the same. More specifically, the present invention provides a tire rubber composition in which carbon black, a processing oil, an anti-aging agent, and additives (fatty acids), which are conventional petrochemical-based compositions used in tire rubber compositions, are extracted and manufactured from lipid-based biomass, a tire using the same, and an environmentally friendly and sustainable tire manufactured using the same.

### Technical Solution

A method for manufacturing a tire composition from biomass according to an embodiment includes (a) adding a single or mixed solvent of alcohol and hydrocarbon-based solvents to lipid-based biomass to prepare an all-in-one activator in which oil, free fatty acids, and phenols are simultaneously extracted, (b) extracting the all-in-one activator and carbonizing remaining residual solids to prepare carbon black, and (c) adding the prepared all-in-one activator and the carbon black to raw rubber.

The lipid-based biomass may be at least one selected from spent coffee grounds, activated sludge, bacteria, plant cells, and animal cells.

The lipid-based biomass may be spent coffee grounds.

The alcohol may be at least one selected from alcohols having 1 to 15 carbon atoms.

The hydrocarbon-based solvent may be at least one selected from hexane, chloroform, dichloromethane, and dichloroethane.

The alcohol and the hydrocarbon-based solvent may be mixed in a ratio of about 3:7 to about 5:5.

Carbon black and the all-in-one activator extracted and prepared from the lipid-based biomass can replace part or all of a reinforcing filler, processing oil, vulcanization accelerator, and anti-aging agent in the tire rubber composition.

The method for manufacturing a tire composition from biomass according to an embodiment may include carbonizing a lipid-based biomass under an inert gas atmosphere or a vacuum atmosphere to produce carbon black, and adding the produced carbon black to a tire composition as a reinforcing filler.

The tire composition according to an embodiment may include an all-in-one activator derived from lipid-based biomass and carbon black.

### Advantageous Effects

The present invention is to replace the conventional petrochemical-based composition as described above, conventional compositions can be partially mixed or used in full, and the aforementioned composition is used for overall tire performance improvement such as reinforcement, processing, and aging in the compound, so that it may be applied not only to the tire tread, but also sidewalls, cord toppings, etc. A lipid-based biomass derived all-in-one activator such as spent coffee grounds and the like, which may replace the petrochemical-based compound added to a conventional tire composition, is an integrated process not requiring a separate purification process for each chemical and thus has an effect of reducing energy consumption, a process cost required for a facility, and a production unit price, and thus improving economic feasibility. In addition, wet spent coffee grounds after brewing coffee may be used without a prior process such as drying, which adds no additional processing cost. This recycling of lipid-based biomass such as the spent coffee grounds and the like may prevent an environmental pollution caused by landfilling the waste biomass, and in addition, may be applied and utilized to various biomass with a similar component profile thereto, agricultural wastes, or the like.

### DESCRIPTION OF DRAWINGS

FIG. 1 is a flowchart for preparing an all-in-one activator and carbon black from lipid-based biomass according to the present invention.

### BEST MODE

Hereinafter, embodiments of the present invention will be described in detail so that those of ordinary skill in the art can easily carry out the present invention. As those skilled in the art would realize, the described embodiments may be modified in various different ways, all without departing from the spirit or scope of the present invention.

A method for manufacturing a tire composition from biomass according to an embodiment includes (a) adding a single or mixed solvent of alcohol and hydrocarbon-based solvents to lipid-based biomass to prepare an all-in-one activator in which oil, free fatty acids, and phenols are simultaneously extracted, (b) extracting the all-in-one activator and carbonizing remaining residual solids to prepare carbon black, and (c) adding the prepared all-in-one activator and the carbon black to raw rubber.

The lipid-based biomass is spent coffee grounds (hereinafter SCG) or activated sludge, bacteria, plant cells, animal cells, and the like, and there is no particular limitation as long as the biomass contains lipids.

Among them, the SCG include cellulose, hemicellulose, lignin, and triglycerides, oil composed of free fatty acids such as C16:0 (palmitic acid), C18:0 (stearic acid), C18:1 (oleic acid), C18:1 (linoleic acid), terpene, phenols, and moisture, and SCG can be obtained very easily due to the recent increase in coffee consumption, and thus its recycling is more desirable because it can reduce the environmental load.

In particular, phenols such as terpene and phenol derivatives contained in SCG can be used by substituting a portion or all of the petrochemical-based phenols used as antioxidants in a tire rubber composition. In addition, in the compound for a tire, stearic acid as a vulcanization accelerator can be replaced with free fatty acid extracted from SCG.

The all-in-one activator can be prepared by simultaneously extracting phenol and its derivatives, free fatty acid, and oil contained in SCG as described above using a solvent. As the solvent, a single or mixed solvent may be used depending on miscibility or solubility with the chemical substance to be extracted, and solvents of alcohol and hydrocarbons may be used. The alcohol may be an alcohol selected from alcohols having 1 to 15 carbon atoms, and desirably methanol, ethanol, propanol, butanol, pentanol, hexanol, heptanol, octanol, nonanol, or decanol, and more desirably methanol, ethanol, or butanol may be used. An example of the hydrocarbon may be hexane or a chlorine-based organic compound, and specific examples thereof may include chloroform (trichloromethane), dichloromethane, dichloroethane, and the like. Water may be used together with the solvent, and when water is included, extraction by phase separation is facilitated, and the content of water is not particularly limited. In order to increase the extraction efficiency of the SCG-derived all-in-one activator, it can be heated below the boiling point of the solvent, desirably below the boiling point of the alcohol.

In the present invention, an amount of the solvent excluding water is desirably about 2 to 5 parts by weight based on 100 parts by weight of the lipid-based biomass. If the amount of the solvent is less than about 2 parts by weight, extraction of the all-in-one activator is not performed well, and if it exceeds about 5 parts by weight, it is inefficient in terms of cost and solvent recycling. In addition, a mass ratio of the alcohol and the hydrocarbon solvent may desirably be about 3:7 to about 5:5, because the extraction efficiency of the all-in-one activator is high within the range.

Even when a single solvent is used, the all-in-one activator can be extracted at a high extraction rate of about 60% to about 80%, but it is more desirable to use a mixed solvent. In particular, an influence of the type and mixing of the solvent is greater than an absolute amount of the solvent, which can be estimated as a result of a difference in solubility due to a difference in miscibility with the solvent, such as oils and lipids, free fatty acids, phenols, etc., included in the lipid-based biomass. A yield of the all-in-one activator derived from lipid-based biomass of the present invention tends to increase as the number of carbon atoms of each alcohol increases, and an amount of extract tends to increase according to the mixed use of organic compounds. In a desired embodiment, when a mixed solvent is prepared and used in a ratio of about 1:1 to about 1:3 of ethanol and chloroform, 95% or more of the all-in-one activator can be extracted.

In the present invention, an organic filler for replacing carbon black, which is part of a tire composition, can be prepared through a conditional carbonization process for the residual solid remaining after obtaining wet residues or lipid-based biomass-derived extracts that have not undergone a separate process. For this purpose, carbonization may be performed at a lower temperature when the carbonization process is performed under an inert gas atmosphere such as N₂ or Ar and a vacuum atmosphere is used. During the carbonization process, the heating temperature may desirably be about 500° C. to about 1500° C., or more desirably about 700° C. to about 1200° C. If it is less than about 700° C., carbonization may not be performed well, and if it exceeds 1200° C., energy efficiency may be reduced. In addition, about 5 hours to about 15 hours of heating time during the carbonization process is appropriate.

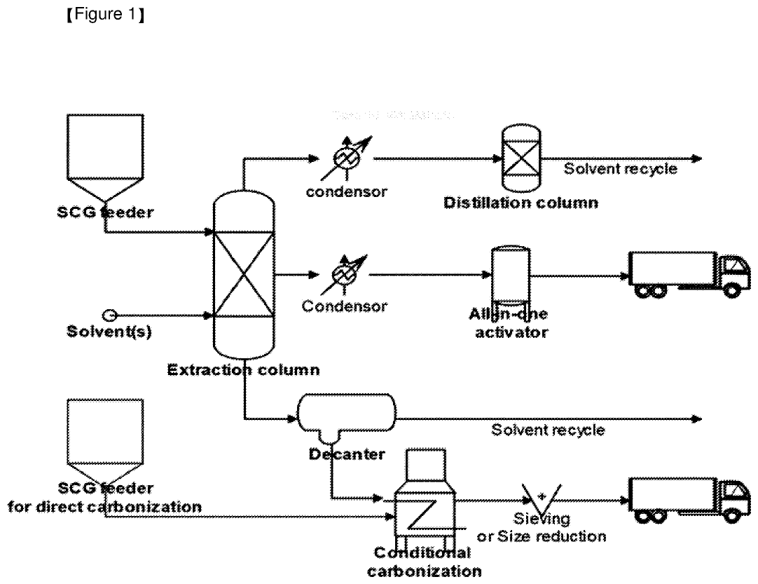

FIG. 1 is a schematic view showing a manufacturing process of an all-in-one activator and carbon black from the lipid-based biomass according to an embodiment.

FIG. 1 shows the process of feeding a lipid-based biomass and a solvent to an extraction column and manufacturing an all-in-one activator through a condenser. The solvent used in the extraction column is reused after purification through a condenser and a distillation column.

In addition, the residual solid discharged from the extraction column is introduced into the decanter, the solvent separated from the decanter is reused, and the remainder undergoes size reduction through conditional carbonization, sieving, or pulverization to manufacture carbon black. On the other hand, in the conditional carbonization process, not the residual solid discharged from the extraction column, but the lipid-based biomass that has not been pretreated can be directly introduced into a furnace and carbonized.

As described above, carbon black obtained from lipid-based biomass and an all-in-one activator are mixed with raw rubber to prepare a biomass-derived tire composition.

The raw rubber may be any one selected from natural rubber, synthetic rubber, or a combination thereof.

The natural rubber has excellent tensile strength and friction resistance, and can be used without any particular limitation as long as it is generally used in a tire rubber composition. Specifically, the natural rubber may be a general natural rubber or a modified natural rubber.

Any general natural rubber may be used as long as it is known as natural rubber, and the country of origin is not limited. The natural rubber contains cis-1,4-polyisoprene as a main component, but may also contain trans-1,4-polyisoprene according to required properties. Accordingly, the natural rubber may include natural rubber containing trans-1,4-isoprene as a main component, such as Valata, which is a type of rubber of the Sapotaceae family from South America in addition to natural rubber containing cis-1,4-polyisoprene as a main component.

The modified natural rubber means a modified or refined natural rubber. For example, examples of the modified natural rubber include epoxidized natural rubber (ENR), deproteinized natural rubber (DPNR), and hydrogenated natural rubber.

The synthetic rubber may be butyl rubber, halogenated butyl rubber, butadiene rubber, styrene butadiene rubber, acrylonitrile butadiene rubber, styrene butadiene styrene rubber, styrene ethylene/butadiene styrene rubber, isoprene rubber, isobutylene isoprene rubber, chloroprene rubber, neoprene rubber, ethylene propylene diene rubber, and the like.

The raw rubber may include about 0 to 40 parts by weight of natural rubber, about 60 to 100 parts by weight of solution-polymerization or emulsion-polymerization styrene-butadiene rubber, and about 0 to 40 parts by weight of butadiene rubber. In addition, the raw rubber is not limited to the type of rubber having a different microstructure including a styrene or vinyl content, functionalization, and related physical properties, or oil content for improving processability.

The tire composition according to the present invention includes a reinforcing filler including carbon black derived from lipid-based biomass according to an embodiment.

Carbon black, which is usually used as a reinforcing agent in a tire rubber composition, does not have a risk of deterioration in abrasion resistance and is excellent in reinforcing performance. Since the carbon black manufactured according to the present invention has little difference in physical properties from that of general carbon black, it may replace the entire amount of carbon black that is generally added. In addition, when silica is mixed with carbon black, durability performance can be improved in a balanced way along with low rolling resistance performance and fuel economy performance without deterioration of abrasion resistance performance, which is a trade-off relationship.

The reinforcing filler may be included in an amount of about 50 to 130 parts by weight based on 100 parts by weight of the raw rubber, and the carbon black manufactured from the lipid-based biomass according to the present invention as a reinforcing filler may be included in an amount of about 1 to 130 parts by weight based on 100 parts by weight of the raw rubber. It may be mixed with silica, carbon nanotubes, and general carbon black.

The all-in-one activator prepared from the lipid-based biomass according to the present invention may include oil, free fatty acids, and phenol.

The oil included in the all-in-one activator may replace a portion or all of the oil commonly used in the tire rubber composition. In addition, a petroleum-based processed oil composed of aromatic, naphthenic, or paraffin-based components used as conventional processed oils or a natural product-based processed oil such as soybean oil and sunflower seed oil may be mixed and used.

It is desirable that the oil contained in the tire rubber composition does not exceed about 1 wt % to about 80 wt % based on 100 parts by weight of the raw rubber including the oil contained in the all-in-one activator. When it exceeds about 80 wt %, there is a disadvantage in that the strength (stiffness) of the rubber composition is rather reduced.

The free fatty acid contained in the all-in-one activator can replace a portion or all of the vulcanization accelerating agent commonly used in rubber compositions for tires. The vulcanization accelerator is a compounding agent used in combination with a vulcanization accelerator to perfect the accelerating effect, and the free fatty acid and any one selected from an inorganic vulcanization accelerator, an organic vulcanization accelerator, and a combination thereof contained in the all-in-one activator may be mixed and used. In particular, it can be used together with zinc oxide as the vulcanization accelerator. In this case, the zinc oxide is dissolved in stearic acid, which is a free fatty acid, to form an effective complex with the vulcanization accelerator, thereby producing advantageous sulfur during the vulcanization reaction and facilitating a crosslinking reaction. The vulcanization accelerator is desirably used at about 1 to 5 parts by weight based on 100 parts by weight of the raw rubber. When the free fatty acid and zinc oxide contained in the all-in-one activator are used together, they may be mixed and used in each amount of about 0.5 to 5 parts by weight and 0.5 to 3 parts by weight based on 100 parts by weight of the raw rubber, in order to serve as an appropriate vulcanization accelerator.

The phenols included in the all-in-one activator can replace a portion or all of petrochemical-based phenolic as an anti-aging agent used in the tire rubber composition. The antioxidant may be an additive used to stop the chain reaction in which the tire is automatically oxidized by oxygen, and together with the all-in-one activator, any one or more selected from an amine-based, phenol-based, quinoline-based, imidazole-based, carbamic acid metal salt, wax, and a combination thereof may be appropriately mixed and used.

The anti-aging agent is desirably used at about 1 to 10 parts by weight, and more desirably about 1 to 5 parts by weight, based on 100 parts by weight of the raw rubber. This is in consideration of the fact that, in addition to the anti-aging action, it should have high solubility in rubber, low volatility, and inertness to rubber, and should not inhibit vulcanization.

The tire rubber composition according to the present invention may optionally further include various additives such as an additional coupling agent, a vulcanizing agent, a vulcanization accelerator, and an activator. Any of the above various additives may be used as long as they are commonly used in the field to which the present invention pertains, and their content is not particularly limited as it depends on a compounding ratio used in a conventional tire rubber composition.

The coupling agent is an additive for improving dispersibility of silica. Any one selected from a silane compound, a methacrylic silane compound, and a combination thereof may be used, and a sulfide-based silane compound may desirably be used.

As the vulcanizing agent, a sulfur-based vulcanizing agent, an organic peroxide, a resin vulcanizing agent, and a metal oxide such as magnesium oxide may be used.

The vulcanization accelerator may include any one selected from sulfenamide, thiazole, thiuram, thiourea, guanidine, dithiocarbamic acid, aldehyde-amine, aldehyde-ammonia, imidazoline, xanthate, and a combination thereof.

A method for manufacturing a tire composition from biomass according to another embodiment includes carbonizing a lipid-based biomass that has not undergone a separate treatment under an inert gas atmosphere or a vacuum atmosphere to produce carbon black, and adding the prepared carbon black to the tire composition as a reinforcing filler. Since this corresponds to the method of manufacturing a tire composition from the same biomass as in the processes of (b) and (c) except for the process (a) for manufacturing an all-in-one activator from the lipid-based biomass described above, descriptions of preparing carbon black and adding the carbon black as a reinforcing agent to the tire composition will be omitted.

In addition, the biomass-derived tire rubber composition according to another embodiment includes carbon black prepared from the lipid-based biomass, and optionally an all-in-one activator prepared from the lipid-based biomass. Since the carbon black and the all-in-one activator are each prepared by the method for preparing a tire composition from the biomass, a description thereof will be omitted.

### MODE FOR INVENTION

Hereinafter, the present invention will be described in more detail through the accompanying tables and examples. In the examples of the present invention, the results applied to the rubber for the tread of the tire have been described, but these examples are only for explaining the present invention in more detail, and it is understood in the art that the scope of the present invention is not limited to these examples as is apparent to those of ordinary skill in the art.

### [Preparation Example 1] Manufacture of All-In-One Activator Including SCG-Derived Oil, Free Fatty Acids, Phenols, Etc.

The coffee grounds used in the present preparation examples were collected from coffee shops in Daejeon. The used SCG used can be considered to be based on coffee beans from various countries such as Colombia, Brazil, Vietnam, Costa Rica, Honduras, Ethiopia, Guatemala, India, and Ethiopia and a variety of species such as Arabica and Robusta can be included. The coffee grounds collected in this way had various moisture contents (5 wt % to 70 wt %).

In the present preparation examples, three solvents were selected and tested based on solubility of stearic acid, a free fatty acid, in the solvents. Accordingly, the alcohol and organic solvents used in the preparation of the SCG-derived all-in-one activator in the present example embodiment included ethanol, hexane, chloroform, or a mixed solvent thereof. Herein, an experiment was carried out by increasing an amount of the organic solvent from 300 mL to 500 mL by 100 mL steps based on 100 g of dry SCG and maintaining an extraction temperature at 50° C. Table 1 shows contents of oil, free fatty acids, and phenols in solvent-extracted (unpurified) crudes, and as shown in Table 2, even when a single solvent was used, an overall high extraction rate of 60% or higher was obtained, and when a mixed solvent of ethanol and chloroform in a ratio of 1:2 was used, a high extraction rate of 99% was obtained. Herein, types of solvents and miscibility thereof were confirmed to have greater influences than an absolute amount of the solvents, which may be explained as a result of solubility differences according to a composition due to miscibility with the aforementioned solvents such as oil, free fatty acids, and the like.

TABLE 1

| Component | Content, wt. % |
|---|---|
| Triglyceride (oil) | 60 |
| Free fatty acids | 15 |
| Phenols | 15 |
| etc. | 10 |
| Sum | 100 |
| *Crude extract content compared to drying weight | 25 |

TABLE 2

| SCG drying | Type and amount of solvent, ml | | All-in-one activator |
|---|---|---|---|
| weight, g | 1 | 2 | extraction yield, % |
| 100 | EtOH, 300 | — | 81.64 ± 4.5 |
| | EtOH, 400 | — | 84.21 ± 1.6 |
| | EtOH, 500 | — | 86.14 ± 0.7 |
| | Hexane, 300 | — | 57.12 ± 0.9 |
| | Hexane, 400 | — | 61.88 ± 0.7 |
| | Hexane, 500 | — | 64.21 ± 3.1 |
| | Chloroform, 300 | — | 72.64 ± 2.4 |
| | Chloroform, 400 | — | 76.45 ± 0.2 |
| | Chloroform, 500 | — | 81.36 ± 6.9 |
| | EtOH, 100 | Chloroform, 200 | 93.12 ± 5.1 |
| | EtOH, 132 | Chloroform, 268 | 99.22 ± 0.4 |
| | EtOH, 165 | Chloroform, 335 | 98.65 ± 1.2 |

※ Based on 100 parts by weight of crude extract

### [Preparation Example 2] Preparation of Organic Filler Using Untreated SCG or Residual Solids after Extraction Process

In Preparation Example 2, an organic filler was prepared by conditionally carbonizing SCG (Sample a) not subjected to a treatment process such as drying and the like or residual solid (Sample b) after the extraction process of Example 1. In the present example embodiment, in order to produce SCG-derived carbon black, the carbonization was carried out by loading the samples under an inert atmosphere with N₂ gas and then increasing a temperature to 800° C. at 10° C./min and maintaining it for at least 8 hours. Subsequently, after cooling it to room temperature, while maintaining the nitrogen atmosphere, sieving or grinding was performed as needed. The carbon black prepared by using Sample a or b was evaluated with respect to properties as shown in [Table 3].

TABLE 3

| | | | Sample b |
|---|---|---|---|
| | N660 | Sample a | Residual solid |
| Component | ref. | Raw SCGs | after extraction |
| Ash contents, % | 7.88 | 6.81 | 9.41 |
| I₂ surface adsorption, m²/g | 34.48 | 55.07 | 39.43 |
| Heat loss, % | 0.05 | 0.03 | 1.45 |
| N₂ surface adsorption, m²/g | 35.03 | 24.77 | 10.70 |
| pH | 6.85 | 10.73 | 10.67 |

### [Example] Tire Rubber Composition Applied with SCG-Derived All-In-One Activator and Carbon Black

The compositions of Table 4 were respectively used to prepare a tire tread rubber composition. The compositions of Table 4 were prepared according to a conventional tire manufacturing method, but is not particularly limited thereto. Comparative Example 1 exhibited a rubber composition prepared by not using the SCG-derived carbon black and the all-in-one activator but adding generally-used carbon black, stearic acid, and an antioxidant. On the contrary, Examples 1 and 2 respectively exhibited rubber compositions including the SCG-derived carbon black alone and the SCG-derived carbon black and the generally-used carbon black in a ratio of 1:1, and Examples 3 and 4 included the generally-used carbon black and the all-in-one activator of the present invention respectively in a partial and total amount. In addition, Examples 5 and 6 exhibited each rubber composition including the SCG-derived carbon black in a partial or total amount and the all-in-one activator of the present invention in a partial or total amount.

TABLE 4

| | Comparative | | | | | | |
|---|---|---|---|---|---|---|---|
| | Example 1 | Example 1 | Example 2 | Example 3 | Example 4 | Example 5 | Example 6 |
| Components | | | | | | | |
| NR | 0 | 0 | 0 | 0 | 0 | 0 | 0 |
| SBR (1) | 100 | 100 | 100 | 100 | 100 | 100 | 100 |
| Si, BET 160-180 m²/g | 80 | 80 | 80 | 80 | 80 | 80 | 80 |
| Silane, Si69 | 6.4 | 6.4 | 6.4 | 6.4 | 6.4 | 6.4 | 6.4 |
| Carbon black (2) | 20 | 0 | 10 | 20 | 20 | 10 | 0 |
| Carbon black (3) | 0 | 20 | 10 | 0 | 0 | 10 | 20 |
| ZnO | 3 | 3 | 3 | 3 | 3 | 3 | 3 |
| Stearic acid | 1 | 1 | 1 | 0.5 | 0 | 0.5 | 0 |
| Sulfur | 1.5 | 1.5 | 1.5 | 1.5 | 1.5 | 1.5 | 1.5 |
| Antioxidant | 2 | 2 | 2 | 1.5 | 1.5 | 1.5 | 1.5 |
| All-in-one activator (4) | 0 | 0 | 0 | 2 | 4 | 2 | 4 |
| Accelerator (5) | 1.5 | 1.5 | 1.5 | 1.5 | 1.5 | 1.5 | 1.5 |
| Evaluation | | | | | | | |
| ML1 + 4 (100° C.) | 75 | 73 | 78 | 72 | 71 | 73 | 68 |
| Hardness (Shore A) | 74 | 73 | 71 | 68 | 67 | 73 | 71 |
| M300 (Index) | 100 | 105 | 108 | 99 | 94 | 103 | 98 |
| Elongation (%) | 582 | 602 | 578 | 603 | 654 | 622 | 578- |
| −60~0° C. tand | 0.124 | 0.126 | 0.107 | 0.111 | 0.105 | 0.132 | 0.127 |
| Average | | | | | | | |
| 0° C. G″ Index | 100 | 194 | 99 | 109 | 107 | 106 | 111 |
| 60° C. tand index | 100 | 94 | 100 | 94 | 96 | 98 | 95 |
| LAT-100 abrasion | 100 | 198 | 195 | 97 | 94 | 101 | 95 |
| Index | | | | | | | |

(1) Non-oil extended, Styr25, vinyl 20, Tg −50° C., S-SBR
(2) Petroleum based carbon black, N330
(3) SCG derived carbon black
(4) SCG derived activator
(5) CBS (N-cyclohexyl-benzothiazylsulfenamide)

The rubber specimens of the examples were measured with respect to Mooney viscosity, hardness, 300% modulus, viscoelasticity, etc. according to ASTM-related standards and also with respect to wear performance according to DIN-related standards, and the results are shown in Table 4.

Mooney viscosity (ML1+4 100° C.) and Shore A hardness were measured according to ASTM standards D1646 and DIN 53505, and M300 and elongation (%) were measured according to ISO 37 standards. The elongation was evaluated by measuring a strain, until the specimens were broken in a tensile tester and expressing it as %. The viscoelasticity was evaluated by using an ARES-measuring instrument and measuring G′, G″, and tan d from −60° C. to 60° C. under a 10 Hz frequency at 0.5% strain, and the wear resistance performance was measured by using LAT-100 Abrasion.

The Mooney viscosity in Table 4 indicates viscosity of unvulcanized rubber, wherein the lower it is, the better the processability. In general, the higher hardness, the better steering stability. As M300 (stress at 300% elongation) is higher, the wear resistance performance was more improved. −30° C. G′ (−60° C. to 0° C. tand Average) indicates braking characteristics on icy and snowy road surfaces, wherein the lower it is the better the braking performance is, and 0° C. G″ indicates braking characteristics on the dry or wet road surfaces, wherein the higher it is, the better the braking performance is. In addition, 60° C. tand indicates rolling resistance characteristics, wherein the lower it is, the better the performance is. Indexes were expressed by indexing based on Comparative Example 1.

Referring to the results of Table 4, when a portion of the SCG-derived carbon black was replaced with currently-used N330, compared with when a total amount thereof was replaced, similar hardness or modulus was maintained, but wear or rolling resistance was slightly deteriorated. The all-in-one activator was somewhat disadvantageous in terms of the hardness or modulus but somewhat played a role as a process oil and thus exhibited overall advantageous results in the snow or wet braking performance test.

Although the preferred embodiment of the present invention has been described in detail, as a result of showing that the coffee-derived composition of the present invention can replace at least a portion of the current petroleum-based tire composition. The scope of the present invention is not limited thereto, and various modifications and improvements by those skilled in the art using the basic concept of the present invention defined in the following claims also fall within the scope of the present invention.

### INDUSTRIAL APPLICABILITY

The present invention relates to the manufacture of a biomass-based tire rubber composition, a compound for a tire to which the same is applied, and a tire manufactured using the same. More specifically, the present invention provides a tire rubber composition in which carbon black, a processing oil, an anti-aging agent, and additives (fatty acids), which are conventional petrochemical-based compositions used in tire rubber compositions, are extracted and manufactured from lipid-based biomass, a tire using the same, and an environmentally friendly and sustainable tire manufactured using the same.

1. A method for manufacturing a tire composition from biomass, comprising:
(a) adding a single or mixed solvent of alcohol and hydrocarbon-based solvents to lipid-based biomass to prepare an all-in-one activator in which oil, free fatty acids, and phenols are simultaneously extracted;
(b) extracting the all-in-one activator and carbonizing remaining residual solids to prepare carbon black; and
(c) adding the prepared all-in-one activator and the carbon black to raw rubber.

2. The method of claim 1, wherein
the lipid-based biomass is at least one selected from spent coffee grounds, activated sludge, bacteria, plant cells, and animal cells.

3. The method of claim 2, wherein
the lipid-based biomass is spent coffee grounds.

4. The method of claim 1, wherein
the alcohol is at least one selected from alcohols having 1 to 15 carbon atoms.

5. The method of claim 1, wherein
the hydrocarbon-based solvent is at least one selected from hexane, chloroform, dichloromethane, and dichloroethane.

6. The method of claim 1, wherein
the alcohol and hydrocarbon-based solvent are mixed in a mass ratio of about 3:7 to about 5:5.

7. The method of claim 1, wherein
in the (c), at least one of a reinforcing filler, a processing oil, a vulcanizing agent, a vulcanization accelerator, a vulcanization accelerator, an anti-aging agent, and an activator is added to the raw rubber.

8. The method of claim 1, wherein
carbon black and the all-in-one activator extracted and prepared from the lipid-based biomass can replace part or all of a reinforcing filler, processing oil, vulcanization accelerator, and anti-aging agent in the tire rubber composition.

9. A method for manufacturing a tire composition from biomass, comprising:
carbonizing a lipid-based biomass under an inert gas atmosphere or a vacuum atmosphere to produce carbon black; and
adding the produced carbon black to a tire composition as a reinforcing filler.

10. A tire composition manufactured by claim 1.
